(19) United States
(12) Patent Application Publication
(10) Pub. No.: US 2021/0027321 A1
(43) Pub. Date: Jan. 28, 2021

(54) INFORMATION PROCESSING SYSTEM, INFORMATION PROCESSING METHOD, AND STORAGE MEDIUM

(71) Applicant: NEC Corporation, Tokyo (JP)

(72) Inventors: Shuji MATSUBAYASHI, Tokyo (JP); Ryo TAKATA, Tokyo (JP)

(73) Assignee: NEC Corporation, Tokyo (JP)

(21) Appl. No.: 17/042,762

(22) PCT Filed: Mar. 1, 2019
(86) PCT No.: PCT/JP2019/007988

§ 371 Date: Sep. 28, 2020

(30) Foreign Application Priority Data
Mar. 29, 2018 (JP) 2018-064709

(51) Int. Cl. G06Q 30/02; G06Q 10/04; G06Q 30/06

(52) U.S. Cl. CPC G06Q 30/0202; G06Q 30/06; G06Q 10/04

(57) ABSTRACT

Provided is an information processing system including: a demand estimation unit that estimates a demand amount based on a plurality of factors; and a display information generation unit that generates display information that causes a display device to display information related to an influence degree that at least one factor of the plurality of factors causes on the demand amount.

### TECHNICAL FIELD

The present invention relates to an information processing system, an information processing method, and a storage medium.

### BACKGROUND ART

Patent Literature 1 discloses a supply amount prediction system that predicts a supply amount such as a sales number of a product or the like. The supply amount prediction system of Patent Literature 1 predicts a supply amount based on a hierarchical latent variable model trained by learning data including a supply amount and an information element that may affect the supply amount.

### CITATION LIST

### Patent Literature

PTL 1: Japanese Patent Application Laid-open No. 2016-537693

### SUMMARY OF INVENTION

### Technical Problem

Patent literature 1 does not clearly disclose a form taken in providing information obtained by demand estimation to a user. When utilizing a result of demand estimation, a user may desire to know a basis for how the result was obtained. For some form of providing information obtained by demand estimation, however, it may be difficult for a user to know a sufficient basis for demand estimation.

The present invention has been made in view of the problems described above and intends to provide an information processing system, an information processing method, and a storage medium that can provide a basis for demand estimation to a user.

### Solution to Problem

According to one example aspect of the present invention, provided is an information processing system including: a demand estimation unit that estimates a demand amount based on a plurality of factors; and a display information generation unit that generates display information that causes a display device to display information related to an influence degree that at least one factor of the plurality of factors causes on the demand amount.

According to another example aspect of the present invention, provided is an information processing method including steps of: estimating a demand amount based on a plurality of factors; and generating display information that causes a display device to display information related to an influence degree that at least one factor of the plurality of factors causes on the demand amount.

According to another example aspect of the present invention, provided is a storage medium storing an information processing program that causes a computer to perform steps of: estimating a demand amount based on a plurality of factors; and generating display information that causes a display device to display information related to an influence degree that at least one factor of the plurality of factors causes on the demand amount.

### Advantageous Effects of Invention

According to the present invention, an information processing system, an information processing method, and a storage medium that can provide a basis for demand estimation to a user can be provided.

### BRIEF DESCRIPTION OF DRAWINGS

FIG. 1 is a block diagram illustrating a network configuration of a POS system according to a first example embodiment.

FIG. 2 is a block diagram illustrating a hardware configuration example of an ordering terminal according to the first example embodiment.

FIG. 3 is a functional block diagram of an information processing system according to the first example embodiment.

FIG. 4 is a flowchart illustrating an overview of a process performed by the information processing system according to the first example embodiment.

FIG. 5 is a conceptual diagram illustrating a demand estimation model based on the heterogeneous mixture learning technology performed by the information processing system according to the first example embodiment.

FIG. 6 is an example of an image displayed on a display device by the information processing system according to the first example embodiment.

FIG. 7 is an example of an image displayed on a display device by the information processing system according to the first example embodiment.

FIG. 8 is an example of an image displayed on a display device by an information processing system according to a second example embodiment.

FIG. 9 is an example of an image displayed on a display device by an information processing system according to a third example embodiment.

FIG. 10 is a functional block diagram of an information processing system according to a fourth example embodiment.

### DESCRIPTION OF EMBODIMENTS

Exemplary example embodiments of the present invention will be described below with reference to the drawings. In the drawings, the same components or corresponding components are labeled with the same references, and the description thereof may be omitted or simplified.

### First Example Embodiment

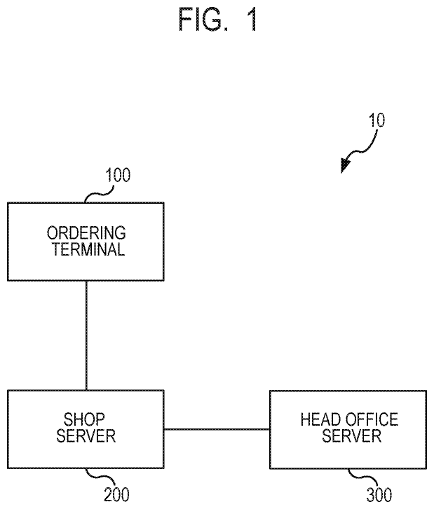

FIG. 1 is a block diagram illustrating a network configuration of a Point of Sales (POS) system 10 according to the present example embodiment. The POS system 10 is a system that performs sales data management, stock management, order placement management, order reception management, or the like. The POS system 10 illustrated in FIG. 1 schematically illustrates a computer network in a chain store. The POS system 10 includes an ordering terminal 100, a shop server 200, and a head office server 300.

The ordering terminal 100 and the shop server 200 are computers provided in a shop such as a retail shop or the like. The ordering terminal 100 and the shop server 200 are communicably connected to each other in a wired or wireless manner. The head office server 300 is a computer provided in the head office. The shop server 200 and the head office server 300 are communicably connected to each other in a wired or wireless manner.

The ordering terminal 100 is a computer used for order input for a product or the like in the shop. The shop server 200 may be a computer used for sales data management, stock management, or the like in the shop. Information on an order quantity or the like input to the ordering terminal 100 is transmitted to the head office server 300 via the shop server 200, and an ordering process is performed. The head office server 300 is a computer used for overall management of the whole chain stores and accepts product order from the shop server 200.

Note that the POS system 10 may be used for retailing business or the like of a business form other than the business form described above. The POS system 10 may be used in a retail shop having a shop and a head office, for example. In such a case, the ordering terminal 100 and the shop server 200 may be computers provided in the shop, and the head office server 300 may be a computer provided in a base of the head office. As described above, some of the ordering terminal 100, the shop server 200, and the head office server 300 may be owned by a different entity.

Further, the network configuration illustrated in FIG. 1 is an example, and an apparatus other than the ordering terminal 100, the shop server 200, and the head office server 300 may be added. A POS register may be added, and stock information registered by a POS register may be automatically shared by the ordering terminal 100, the shop server 200, or the head office server 300, for example. Alternatively, an apparatus that accepts product order may be a server at a distribution base instead of the head office server 300.

Further, some of the ordering terminal 100, the shop server 200, and the head office server 300 may be integrated in one apparatus. In a small scale shop, a computer in the shop may have both the function of the ordering terminal 100 and the function of the shop server 200, for example.

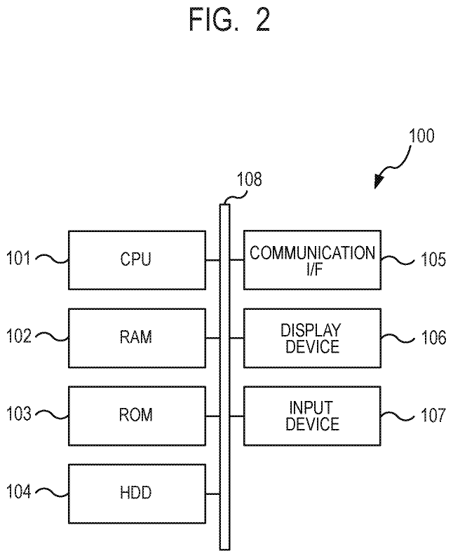

FIG. 2 is a block diagram illustrating a hardware configuration example of the ordering terminal 100 according to the present example embodiment. The ordering terminal 100 may be a desktop computer, a laptop computer, a tablet computer, a personal digital assistant (PDA), a smartphone, or the like.

The ordering terminal 100 has a central processing unit (CPU) 101, a random access memory (RAM) 102, a read only memory (ROM) 103, and a hard disk drive (HDD) 104 as a computer that performs calculation, control, and storage. Further, the ordering terminal 100 has a communication interface (I/F) 105, a display device 106, and an input device 107. The CPU 101, the RAM 102, the ROM 103, the HDD 104, the communication I/F 105, the display device 106, and the input device 107 are connected to each other via a bus 108. Note that the display device 106 and the input device 107 may be connected to the bus 108 via a drive device (not illustrated) used for driving these devices.

Although respective components forming the ordering terminal 100 are illustrated as a single integrated apparatus in FIG. 2, some of these functions may be provided by an external device. The display device 106 and the input device 107 may be external devices different from the portion forming a function of a computer including the CPU 101 or the like, for example.

The CPU 101 performs a predetermined operation according to a program stored in the ROM 103, the HDD 104, or the like and also has a function of controlling each component of the ordering terminal 100. The RAM 102 is formed of a volatile storage medium and provides a temporary memory area required for the operation of the CPU 101. The ROM 103 is formed of a nonvolatile storage medium and stores required information such as a program used for the operation of the ordering terminal 100. The HDD 104 is a storage device that is formed of a nonvolatile storage medium and stores data required for a process, a program for operating the ordering terminal 100, or the like.

The communication I/F 105 is a communication interface based on a specification such as Ethernet (registered trademark), Wi-Fi (registered trademark), 4G, or the like and a module used for communicating with other devices. The display device 106 is a liquid crystal display, an organic light emitting diode (OLED) display, or the like and is used for displaying an image, a text, an interface, or the like. The input device 107 is a keyboard, a pointing device, or the like and is used by a user to operate the ordering terminal 100. An example of pointing device may be a mouse, a trackball, a touchscreen, or the like. The display device 106 and the input device 107 may be integrally formed as a touchscreen.

Note that the hardware configuration illustrated in FIG. 2 is an example, and a device other than the devices described above may be added, or some of the devices may not be provided. Further, some of the devices may be replaced with another device having the same function. Furthermore, some functions of the present example embodiment may be provided by another apparatus via a network, and the functions of the present example embodiment may be distributed and implemented in a plurality of apparatuses. The HDD 104 may be replaced with a solid state drive (SDD) using a semiconductor memory or may be replaced with cloud storage, for example.

The shop server 200 and the head office server 300 may be implemented by the same hardware configuration as that of the ordering terminal 100 illustrated in FIG. 2. Therefore, the description of the hardware configuration of the shop server 200 and the head office server 300 will be omitted.

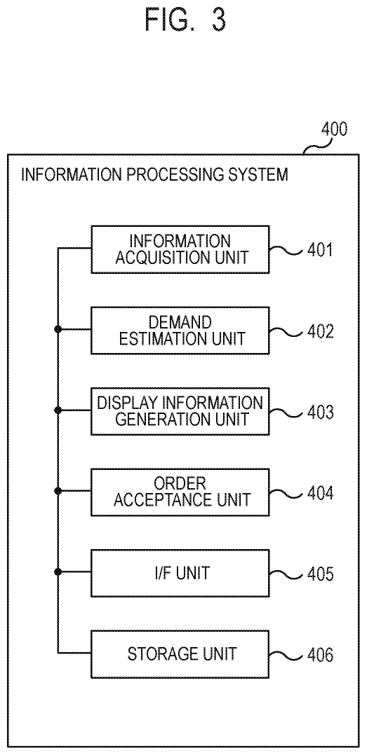

FIG. 3 is a functional block diagram of an information processing system 400 according to the present example embodiment. The function of the information processing system 400 may be implemented by any of the ordering terminal 100, the shop server 200, and the head office server 300 or may be implemented in cooperation of two or more of these devices. In the description below, the function of the information processing system 400 is implemented by the ordering terminal 100.

The information processing system 400 has an information acquisition unit 401, a demand estimation unit 402, a display information generation unit 403, an order acceptance unit 404, an I/F unit 405, and a storage unit 406. The CPU 101 implements the functions of the information acquisition unit 401, the demand estimation unit 402, the display information generation unit 403, and the order acceptance unit 404 by loading a program stored in the ROM 103, the HDD 104, or the like into the RAM 102 and executing the loaded program. The CPU 101 implements the function of the I/F unit 405 by controlling the communication I/F 105 and implements the function of the storage unit 406 by controlling the HDD 104. The process performed in each of these units will be described later.

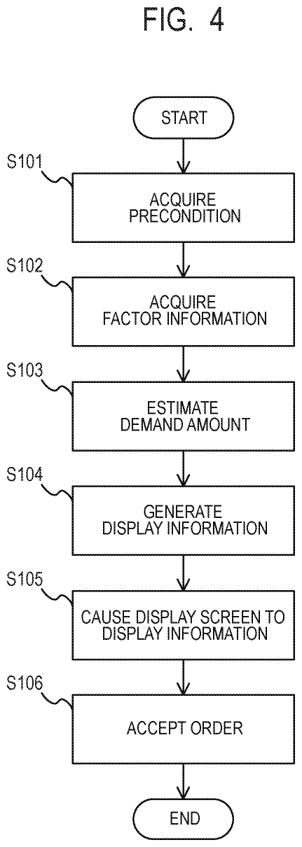

FIG. 4 is a flowchart illustrating the process performed by the information processing system 400 according to the present example embodiment. A payment-related process performed by the information processing system 400 will be described with reference to FIG. 4.

When a user such as a person responsible for order placement or the like of the shop operates the ordering terminal 100 and causes the ordering terminal 100 to execute an ordering program, the process in FIG. 4 is started. Thereby, the ordering terminal 100 functions as the information processing system 400.

In step S101, the information acquisition unit 401 acquires a precondition for order placement to be performed by the user. Such acquisition of a precondition may be acceptance of an input from the user, reading of the information pre-stored in the storage unit 406, or acquisition from another device such as the shop server 200 or the like via a network.

The precondition may be, for example, a condition related to a product, such as a product name, a category (articles of food, household goods, or the like), an order destination, a price, an order unit, or the like of the product for which the order is to be placed or a condition related to order placement such as a name of an ordering shop, a name of a person responsible for order placement, an expected date of order placement, the current time, or the like.

In step S102, the information acquisition unit 401 acquires factor information related to a plurality of factors that may influence the demand amount. Such acquisition of the factor information may be acceptance of input from the user, reading of the information pre-stored in the storage unit 406, or acquisition from another device such as the shop server 200 or the like via a network. Further, acquisition of the factor information may be calculation based on the precondition described above.

The factors to be acquired by the information acquisition unit 401 in such a process may include various factors as long as they may influence the demand. A factor may be a special factor that occurs around the order date, such as a sales promotion activity (campaign) such as discounts or the like, an event (neighborhood event) held near the shop, an activity (special event) held at the shop, an advertisement or an introductory article (CM/media) in media such as TV, a magazine, or the like, for example. Alternatively, the factor may be an attribute of the order date itself, such as the order date category (weekday/holiday, day of week), the seasonal weather (temperature, weather) of the order date, or the like, for example.

In step S103, the demand estimation unit 402 estimates a demand amount based on a plurality of factors acquired in step S102. Here, the demand amount may be various indicators related to purchase power such as the sales number, the sales amount, the number of visitors or the like at the shop, and prediction of the sales number may be included in the estimation of the demand amount, for example. As an example of the algorithm used for the demand amount estimation, an estimation model based on the heterogeneous mixture learning technology can be employed.

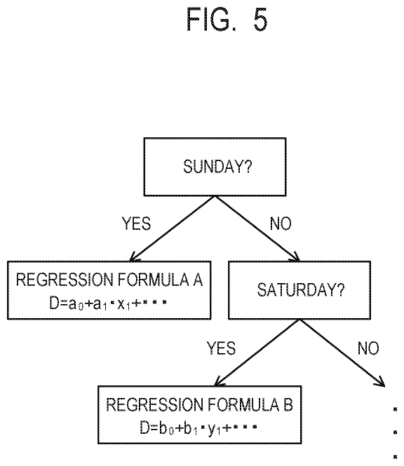

An overview of an estimation model based on the heterogeneous mixture learning technology will now be described with reference to FIG. 5. FIG. 5 is a conceptual diagram illustrating a demand estimation model performed by the information processing system 400 according to the first example embodiment. In the estimation model based on the heterogeneous mixture learning technology, classification by a decision tree and regression formulas corresponding to each of the results of the classification are combined. Note that the configuration example of a decision tree in FIG. 5 has been simplified for illustration, and a decision tree may be a complex decision tree with more factors in the actual implementation.

In the example of FIG. 5, first, “Day of week” of the factors are referenced to determine whether or not the day is Sunday. If the “Day of week” is Sunday, a demand amount D, which is a response variable, can be calculated by using a regression formula A. If the “Day of week” is not Sunday, “Day of week” of the factors are referenced again to determine whether or not the day is Saturday. If the “Day of week” is Saturday, the demand amount D can be calculated by using a regression formula B. Subsequently, classification and determination of regression formulas are performed in the same manner. As illustrated in FIG. 5, the regression formula A and the regression formula B may be linear regression formulas with one or more explanatory variables. The configuration of a decision tree and parameters for regression formulas may be determined by machine learning using an achievement value of the demand amount in the past as training data. In step S103, the demand estimation unit 402 performs this process by using a trained estimation model.

Here, each of the parameters x₁, y₁, . . . in the regression formulas A and B is an explanatory variable corresponding to a factor such as “Temperature”, “Day of week”, or the like, and the parameters a₀, a₁, b₀, b₁, . . . in the regression formulas A and B are coefficients each indicating an influence degree of each factor. When a factor that is difficult to be quantified, such as the presence or absence of “Campaign” or the like, is used as the explanatory variable, a dummy variable may be employed.

The number of customers visiting a shop greatly varies depending on the day of the week. It is known that, in a retail shop on a business district, for example, the number of customers visiting the shop on the holiday is smaller than the number of customers visiting the shop on weekdays. In such a case, a use of a general regression analysis in which the same regression formula is used for different days of the week may result in a large error. On the other hand, when performing classification by using decision trees for each day of the week and using different regression formulas for respective days of the week, the above influence is reduced. As described above, a factor to be used for classification is included in a plurality of factors. With the heterogeneous mixture learning technology, it is possible to construct a demand estimation model that supports various factors.

Note that the algorithm used for the demand amount estimation is not limited to the estimation model based on the heterogeneous mixture learning technology described above, and an algorithm other than the above may be used. However, since a process for displaying the influence degree of the factor is performed in a process described later, it is desirable that the influence degree of the factor be able to be easily extracted from the model, that is, the algorithm be not a black box. For example, in a model using a neural network such as deep learning, a content of a model obtained by learning may be a black box, and extraction of the influence degree may be difficult. In contrast, the estimation model based on the heterogeneous mixture learning technology is preferable because the content of the model is clear and the influence degree of the factor can be directly acquired in a form of a coefficient or the like of the regression formula.

In step S104, the display information generation unit 403 generates display information that causes the display device 106 to display information related to an influence degree that a factor causes on the demand amount. In step S105, the information processing system 400 supplies display information to the display device 106 to cause information to be displayed on a display screen. Note that the information may be displayed on the display device 106 in an apparatus to which the display information generation unit 403 is provided or may be displayed on the display device 106 in another apparatus. When the display device 106 is a device outside the information processing system 400, the display information is supplied to the display device 106 via the I/F unit 405, for example.

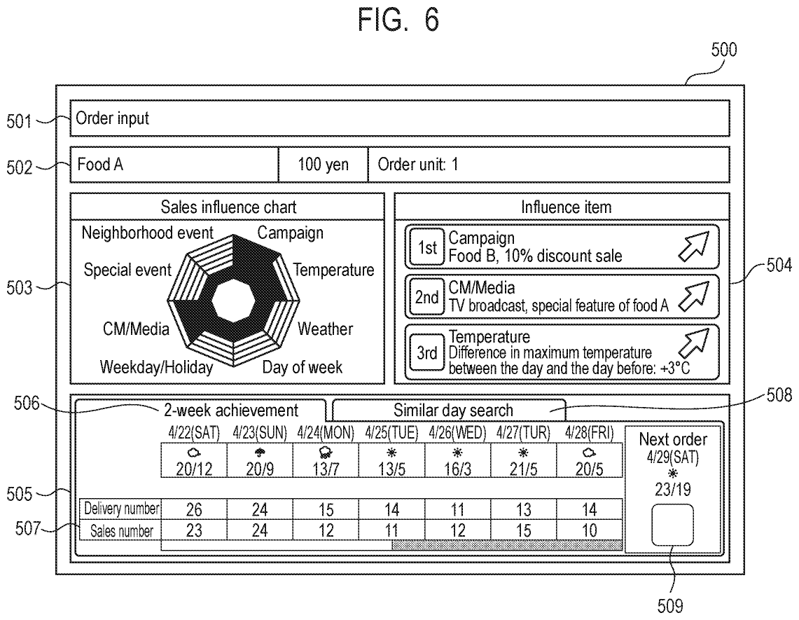

An example of an image displayed on the display device 106 will be described with reference to FIG. 6. FIG. 6 is an example of an image displayed on the display device 106 by the information processing system 400 according to the present example embodiment. The example of FIG. 6 is an order input window by which a person responsible for order placement in the shop performs order input. The order input window has a function of displaying information estimated by the demand estimation unit 402 in addition to a function of the graphical user interface for order input.

An order input window 500 has a title display portion 501, a product information display portion 502, a sales influence chart display portion 503, an influence item display portion 504, and a past achievement display portion 505.

The title display portion 501 is a portion for displaying a title of the order input window 500. Since this example is the order input window, a title “Order input” is displayed in the title display portion 501.

The product information display portion 502 is a portion for displaying information on a product, and some or all of the preconditions acquired in the information acquisition unit 401 are displayed. In this example, a product name “Article of food A”, a price “100 yen”, and an order unit are displayed on the product information display portion 502.

The sales influence chart display portion 503 is a portion in which an item name and an influence degree of a factor that influences the sales number, which is one example of the demand amount, are listed and displayed as “Sales influence chart”. In this example, as the item names of the factors, “Neighborhood event”, “Special event”, “CM/Media”, “Weekday/Holiday”, “Day of week”, “Weather”, “Temperature”, and “Campaign” are displayed. Further, the item name and the level of the influence degree of each factor are illustrated on the sales influence chart display portion 503. Thereby, a user may easily recognize the influence degree of each factor. In this example, it is found that the influence degrees of “Campaign”, “CM/Media”, and “Temperature” are large. The influence degree may be directly determined from the model of the demand estimation unit 402 such as the level of the coefficient of the regression formula or the like, for example, or may be determined by utilizing the model of the demand estimation unit 402 to perform predetermined calculation as with the level of the amount of a change in the sales quantity obtained when each factor is changed.

The influence item display portion 504 is a portion in which the item names of the factors that influence the sales number and information on an increase or decrease in the sales number due to each factor are displayed as “Influence item”. In this example, the field of “Campaign” having the largest influence degree on an increase or decrease in the sales number, the field of “CM/Media” having the second largest influence degree, and the field of “Temperature” having the third largest influence degree are vertically aligned and displayed. Further, an arrow is displayed on each field so that whether the sales number is increasing or decreasing can be seen. Since a diagonally upward arrow is displayed in FIG. 6, it is found that an increase in the sales number is estimated. Accordingly, the user may recognize at a glance an important factor having a large influence degree and a direction of the influence thereof.

Further in each field, a specific content of the factor of “Campaign” or the like is also displayed. In the field of “Campaign”, for example, “Article of food B 10% discount sale” is displayed. By indicating a specific content in such a way, it is possible to provide an opportunity to facilitate a better understanding such as “the discount sale of the article of food B increases the sales number of the article of food A that is often purchased together with the article of food B” to the user.

Each field of the influence item display portion 504 may be a button that can be operated by performing a selection operation such as a click with a mouse. In response to a click of each field, a window in which further specific contents are described may be displayed. In response to a click of the field of “Campaign”, for example, an image of a sales advertisement may be displayed.

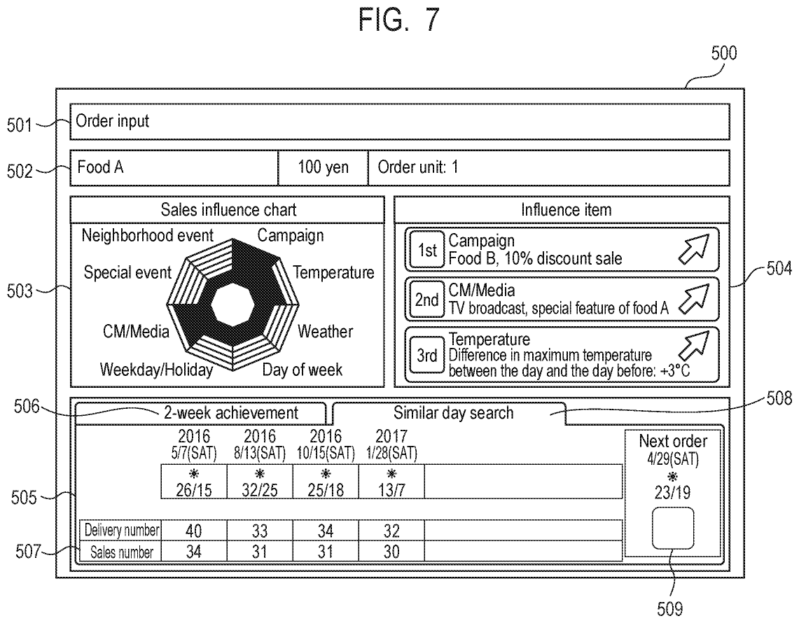

The past achievement display portion 505 is a portion on which the achievement value of the demand amount such as the past delivery number of the article of food A or the like is displayed. The past achievement display portion 505 is provided with two tabs of a two-week achievement tab 506 and a similar day search tab 508. The user may switch the screen between the screen of FIG. 6 and the screen of FIG. 7 by selecting the tabs. In FIG. 6, a display example when the two-week achievement tab 506 is selected is illustrated.

On the past achievement display portion 505, an achievement display portion 507 in which the past delivery number (or the order number) and the sales number of the article of food A are summarized in a table format for each arrival timing of a delivery service is displayed. In this example, an example of order placement in a shop where delivery is performed once a day is illustrated. Further, the weather on each day, the maximum temperature on each day, and the minimum temperature on each day are displayed above the achievement display portion 507. With the configuration described above, the user may consider the order quantity by further referencing a past achievement, the seasonal weather of the day, or the like in addition to information on demand estimation. Note that, although delivery is performed once a day in this example, the example embodiment is also applicable to a shop where delivery is performed multiple times a day.

Note that “past” in past achievements displayed on the past achievement display portion 505 means the time earlier than the order target date, that is, earlier than the estimation target time of the demand amount as a reference. Therefore, the past achievement displayed on the past achievement display portion 505 may include current or future information with respect to a point of time when the order input window 500 of FIG. 6 was displayed, that is, a point of time of the order input.

Although only the achievement for one week from the day before the point of time of the order input is illustrated in FIG. 6, the user may browse the achievements for two weeks by operating a scroll bar provided below the achievement display portion 507.

Further, an order quantity input portion 509 that accepts an input of an order quantity corresponding to next order is displayed on the past achievement display portion 505. The order quantity input portion 509 is a user interface that accepts the input of an order amount. The user may input the order quantity of the article of food A by selecting each of the order quantity input portions 509 to input a numerical value.

Note that information used for displaying a past achievement may be acquired by the display information generation unit 403 reading the information pre-stored in the storage unit 406.

Once the user selects the similar day search tab 508, the displayed contents on the past achievement display portion 505 are switched to a similar day display illustrated in FIG. 7. Although the past achievements for last two weeks before the order date are displayed in the example of FIG. 6, the past achievement of the date and time on which the relationship between the factor and the influence degree is similar to that on the estimation target date and time of the demand amount is displayed in the similar day display of Fig. unlike the example of FIG. 6. In more specific description with the example of FIG. 7, out of the past achievements, the past achievements of the day when the influence degrees of “Campaign”, “CM/Media”, and “Temperature” are large and the shape of the sales influence chart is similar is displayed.

By using the function of similar day search, the user may reference the achievement of the day on which the shape of the sales influence chart is similar out of the past achievements, and thereby the user may place an order by using information on the day in a situation closer to that of the order target day.

Note that the similar day search may be performed after the demand estimation unit 402 estimates the demand amount or may be performed at the timing when the user selects the similar day search tab 508 by the display information generation unit 403 searching the storage unit 406 for a past achievement.

In step S106, after the user inputs a numerical value in each order quantity input portion 509, the information processing system 400 accepts the quantity as an order input of the article of food A. Order information accepted by this process is provided to the head office server 300 via the I/F unit 405, the shop server 200, or the like. The head office server 300 performs a process for order placement based on the order information. Note that, a transmission timing of the order information may be each time the user inputs the order quantity of each product or may be a point of time when the user completes input of all the ordering products and then issues another order instruction.

According to the present example embodiment, as displayed in the sales influence chart display portion 503 or the like, the information processing system 400 can cause information on an influence degree of a factor to be displayed on the display device 106 and provide the information to the user. Therefore, according to the present example embodiment, the information processing system 400 that can provide a basis for demand estimation to the user is provided.

The user may place an order after recognizing a basis for demand estimation performed by the information processing system 400 and thus can set a more appropriate order amount in consideration of a factor that influences the demand. Accordingly, an order quantity can be determined at higher accuracy, and out-of-stock, waste loss, or the like due to a difference between the order amount and the actual demand may be reduced.

### Second Example Embodiment

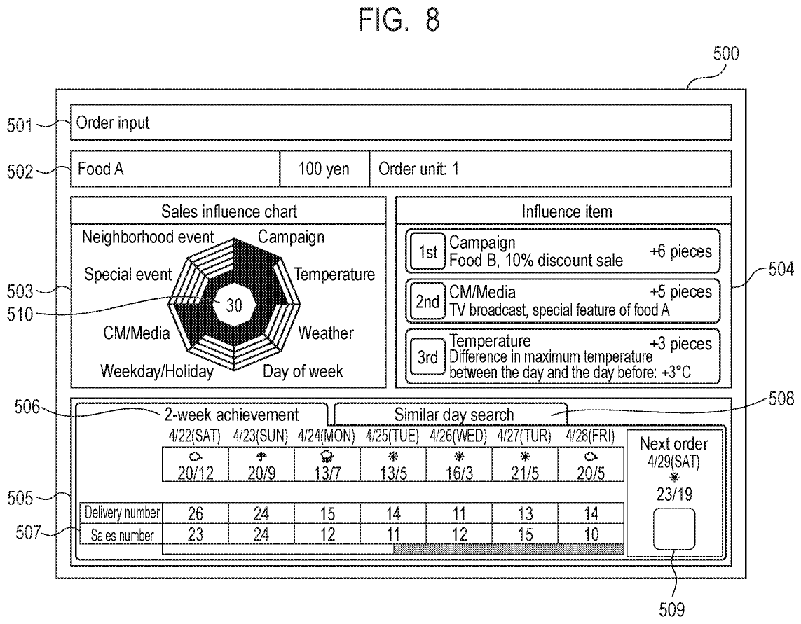

Next, an example that causes the demand estimation unit 402 to quantitatively display an estimation result will be described as a second example embodiment. In the description of the present example embodiment, the description duplicated with that of the first example embodiment may be omitted or simplified. FIG. 8 is an example of an image displayed on the display device 106 by the information processing system 400 according to the present example embodiment.

In the sales influence chart display portion 503, a predicted sales number display portion 510 is provided in the center of the chart. The predicted sales number display portion 510 is a portion in which the value of a demand amount estimated by the demand estimation unit 402 is displayed. In the present example, the predicted sales number display portion 510 displays that a predicted sales number of the article of food A is 30. The predicted sales number is calculated from the demand amount D estimated by the demand estimation unit 402.

Further, in a field of each factor on the influence item display portion 504, an increase or decrease in the sales number is displayed as a specific numerical value instead of an arrow. For example, in the item of “Campaign” of the first place, “+6 pieces” is displayed, which enables the user to recognize at a glance and quantitatively that the 10% discount sale of the article of food B causes an influence that the sales number of the article of food A increases by 6.

The user may decide a numerical value input to the order quantity input portion 509 so as to have the total of 30 based on the predicted sales number displayed on the predicted sales number display portion 510 or may input a numerical value different from the above to the order quantity input portion 509 based on the user's own prediction.

As described above, in the present example embodiment, by quantitatively displaying a result of estimation performed by the demand estimation unit 402, it is possible to provide a specific result of demand estimation to the user in addition to a basis for demand estimation.

### Third Example Embodiment

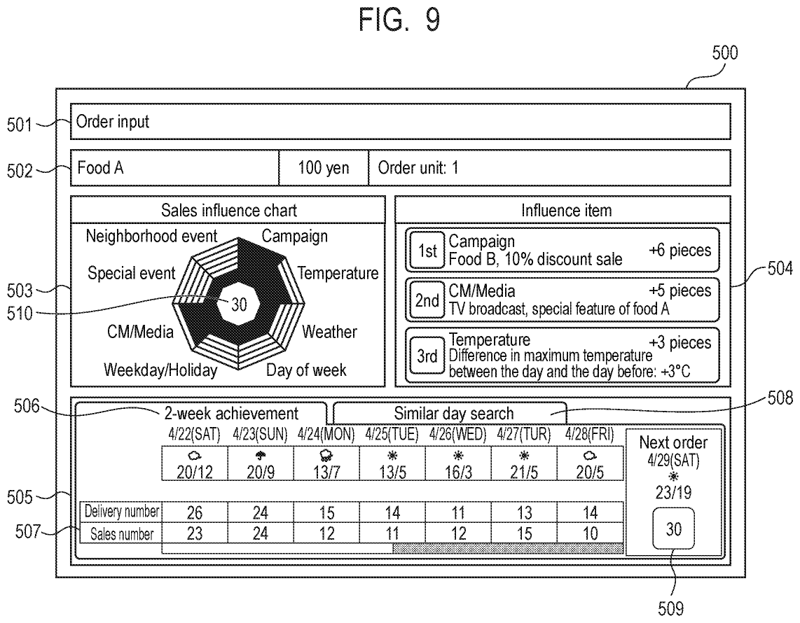

Next, as a third example embodiment, an example in which the demand estimation unit 402 further calculates a recommended order amount and the recommended order amount is automatically displayed on the order quantity input portion 509 will be described. In the description of the present example embodiment, the description duplicated with that of the first example embodiment or the second example embodiment may be omitted or simplified. FIG. 9 is an example of an image displayed on the display device 106 by the information processing system 400 according to the present example embodiment.

In the present example embodiment, a recommended order amount is further calculated based on a demand amount and a stock amount after the demand estimation unit 402 performs demand estimation. A calculation scheme of the recommended order amount may be subtraction of a stock number at a point of time of delivery from the estimated sales number, for example.

As illustrated in FIG. 9, a recommended order amount for each date is displayed in advance on the order quantity input portion 509. In the example of FIG. 9, “30”, which is the recommended order amount, is displayed in advance in an input field of the order quantity input portion 509. When placing an order in accordance with the recommended order amount, the user may simply complete the order input or may input a numerical value different from the above to the order quantity input portion 509 based on the user's own prediction.

In the present example embodiment, by quantitatively displaying a recommended order amount, it is possible to more directly provide a specific result of demand estimation to the user. Further, since no input is required when an order is placed without a change from the recommended order amount, a workload of the user is reduced.

The system described in the above example embodiments may also be configured as in a fourth example embodiment described below.

### Fourth Example Embodiment

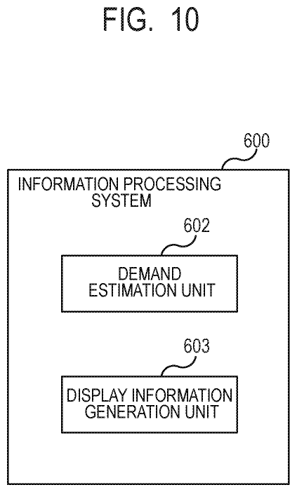

FIG. 10 is a functional block diagram of an information processing system 600 according to a fourth example embodiment. The information processing system 600 has a demand estimation unit 602 and a display information generation unit 603. The demand estimation unit 602 estimates a demand amount based on a plurality of factors. The display information generation unit 603 generates display information that causes a display device to display information related to an influence degree that at least one factor of the plurality of factors causes on the demand amount.

According to the present example embodiment, the information processing system 600 that can provide a basis for demand prediction to a user is provided.

### Modified Example Embodiment

The present invention is not limited to the example embodiments described above and can be properly changed within the scope not departing from the spirit of the present invention.

The scope of each of the example embodiments further includes a processing method that stores, in a storage medium, a program that causes the configuration of each of the example embodiments to operate so as to implement the function of each of the example embodiments described above, reads the program stored in the storage medium as a code, and executes the program in a computer. That is, the scope of each of the example embodiments also includes a computer readable storage medium. Further, each of the example embodiments includes not only the storage medium in which the program described above is stored but also the program itself. Further, one or two or more components included in the example embodiments described above may also be a circuit configured to implement the function of each component such as an application specific integrated circuit (ASIC), field-programmable gate array (FPGA), or the like.

As the storage medium, for example, a floppy (registered trademark) disk, a hard disk, an optical disk, a magneto-optical disk, a compact disk (CD)-ROM, a magnetic tape, a nonvolatile memory card, or a ROM can be used. Further, the scope of each of the example embodiments includes an example that operates on OS to perform a process in cooperation with another software or a function of an add-in board without being limited to an example that performs a process by an individual program stored in the storage medium.

A service implemented by the function of each of the example embodiment described above may also be provided to the user in a form of Software as a Service (SaaS).

Note that each of the example embodiments described above merely illustrates an embodied example in implementing the present invention, and the technical scope of the present invention is not to be construed by these example embodiments. That is, the present invention can be implemented in various forms without departing from the technical concept thereof or the primary features thereof.

The whole or part of the example embodiments disclosed above can be described as, but not limited to, the following supplementary notes.

### (Supplementary Note 1)

An information processing system comprising:

a demand estimation unit that estimates a demand amount based on a plurality of factors; and

a display information generation unit that generates display information that causes a display device to display information related to an influence degree that at least one factor of the plurality of factors causes on the demand amount.

### (Supplementary Note 2)

The information processing system according to supplementary note 1, wherein the display information to be displayed on the display device includes an item name of at least one factor of the plurality of factors and the influence degree corresponding to each of the at least one factor.

### (Supplementary Note 3)

The information processing system according to supplementary note 1 or 2, wherein the display information to be displayed on the display device includes an item name of at least one factor of the plurality of factors and information related to an increase or decrease of the demand amount due to each of the at least one factor.

### (Supplementary Note 4)

The information processing system according to supplementary note 3, wherein the item name of at least one factor of the plurality of factors and the information related to an increase or decrease of the demand amount due to each of the at least one factor are displayed in descending order of an amount of an increase or decrease in the demand amount.

### (Supplementary Note 5)

The information processing system according to any one of supplementary notes 1 to 4, wherein the display information to be displayed on the display device includes information indicating a specific content of at least one factor of the plurality of factors.

### (Supplementary Note 6)

The information processing system according to any one of supplementary notes 1 to 5, wherein the display information to be displayed on the display device includes information indicating an achievement value of the demand amount in the past earlier than an estimation target time of the demand amount.

### (Supplementary Note 7)

The information processing system according to supplementary note 6, wherein the achievement value is selected from a past achievement value in which a relationship between the plurality of factors and the influence degree is similar to that at the estimation target time.

### (Supplementary Note 8)

The information processing system according to any one of supplementary notes 1 to 7, wherein the demand estimation unit calculates the demand amount by using an estimation model including classification by a decision tree and regression formulas corresponding to respective results of the classification.

### (Supplementary Note 9)

The information processing system according to any one of supplementary notes 1 to 8, wherein the display information to be displayed on the display device includes information indicating a value of the demand amount estimated by the demand estimation unit.

### (Supplementary Note 10)

The information processing system according to any one of supplementary notes 1 to 9, wherein the display information to be displayed on the display device includes a user interface that accepts input of an order amount.

### (Supplementary Note 11)

The information processing system according to any one of supplementary notes 1 to 10, wherein the display information to be displayed on the display device includes a recommended order amount calculated based on the demand amount estimated by the demand amount estimation unit and a stock amount.

### (Supplementary Note 12)

The information processing system according to supplementary note 11, wherein the recommended order amount is displayed on a user interface that accepts input of an order amount.

### (Supplementary Note 13)

An information processing method comprising:

estimating a demand amount based on a plurality of factors; and

generating display information that causes a display device to display information related to an influence degree that at least one factor of the plurality of factors causes on the demand amount.

### (Supplementary Note 14)

A storage medium storing an information processing program that causes a computer to perform:

estimating a demand amount based on a plurality of factors; and

generating display information that causes a display device to display information related to an influence degree that at least one factor of the plurality of factors causes on the demand amount.

This application is based upon and claims the benefit of priority from Japanese Patent Application No. 2018-064709, filed on Mar. 29, 2018, the disclosure of which is incorporated herein in its entirety by reference.

### REFERENCE SIGNS LIST

10 POS system
100 ordering terminal
101 CPU
102 RAM
103 ROM
104 HDD
105 communication I/F
106 display device
107 input device
108 bus
200 shop server
300 head office server
400, 600 information processing system
401 information acquisition unit
402, 602 demand estimation unit
403, 603 display information generation unit
404 order acceptance unit
405 I/F unit
406 storage unit
500 order input window
501 title display portion
502 product information display portion
503 sales influence chart display portion
504 influence item display portion
505 past achievement display portion
506 two-week achievement tab
507 achievement display portion
508 similar day search tab
509 order quantity input portion
510 predicted sales number display portion

1. An information processing system comprising:
a demand estimation unit that estimates a demand amount based on a plurality of factors; and
a display information generation unit that generates display information that causes a display device to display information related to an influence degree that at least one factor of the plurality of factors causes on the demand amount.

2. The information processing system according to claim 1, wherein the display information to be displayed on the display device includes an item name of at least one factor of the plurality of factors and the influence degree corresponding to each of the at least one factor.

3. The information processing system according to claim 1, wherein the display information to be displayed on the display device includes an item name of at least one factor of the plurality of factors and information related to an increase or decrease of the demand amount due to each of the at least one factor.

4. The information processing system according to claim 3, wherein the item name of at least one factor of the plurality of factors and the information related to an increase or decrease of the demand amount due to each of the at least one factor are displayed in descending order of an amount of an increase or decrease in the demand amount.

5. The information processing system according to claim 1, wherein the display information to be displayed on the display device includes information indicating a specific content of at least one factor of the plurality of factors.

6. The information processing system according to claim 1, wherein the display information to be displayed on the display device includes information indicating an achievement value of the demand amount in the past earlier than an estimation target time of the demand amount.

7. The information processing system according to claim 6, wherein the achievement value is selected from a past achievement value in which a relationship between the plurality of factors and the influence degree is similar to that at the estimation target time.

8. The information processing system according to claim 1, wherein the demand estimation unit calculates the demand amount by using an estimation model including classification by a decision tree and regression formulas corresponding to respective results of the classification.

9. The information processing system according to claim 1, wherein the display information to be displayed on the display device includes information indicating a value of the demand amount estimated by the demand estimation unit.

10. The information processing system according to claim 1, wherein the display information to be displayed on the display device includes a user interface that accepts input of an order amount.

11. The information processing system according to claim 1, wherein the display information to be displayed on the display device includes a recommended order amount calculated based on the demand amount estimated by the demand amount estimation unit and a stock amount.

12. The information processing system according to claim 11, wherein the recommended order amount is displayed on a user interface that accepts input of an order amount.

13. An information processing method comprising:
estimating a demand amount based on a plurality of factors; and
generating display information that causes a display device to display information related to an influence degree that at least one factor of the plurality of factors causes on the demand amount.

14. A non-transitory storage medium storing an information processing program that causes a computer to perform:
estimating a demand amount based on a plurality of factors; and
generating display information that causes a display device to display information related to an influence degree that at least one factor of the plurality of factors causes on the demand amount.
